(19) United States
(12) Patent Application Publication
(10) Pub. No.: US 2025/0069178 A1
(43) Pub. Date: Feb. 27, 2025

(54) Monitoring A Motor Vehicle During An At Least Highly Automated Journey Within A Parking Area

(71) Applicant: Robert Bosch GmbH, Stuttgart-Feuerbach (DE)

(72) Inventors: Stefan Nordbruch, Leonberg (DE); Nico Latsch, Oppenweiler (DE); Felix Hess, Benningen (DE); Michael Gabb, Gaufelden (DE); Sebastian Hahn, Sindelfingen (DE); Sascha Muhlbrandt, Wiernsheim (DE); Carsten Hammerling, Gartringen (DE)

(73) Assignee: Robert Bosch GmbH, Stuttgart-Feuerbach (DE)

(21) Appl. No.: 18/812,605

(22) Filed: Aug. 22, 2024

(30) Foreign Application Priority Data
Aug. 22, 2023 (DE) 10 2023 122 461.1

(51) Int. Cl. G06Q 50/40; B60W 60/00; G07C 5/02

(52) U.S. Cl. CPC G06Q 50/40; B60W 60/005; G07C 5/02; B60W 2520/10; B60W 2520/105; B60W 2556/45

(57) ABSTRACT

A method for monitoring, on the infrastructure side, a highly automated journey of a motor vehicle within a parking area, including the steps of receiving, on the infrastructure side, motor vehicle state data which are transmitted by the motor vehicle during an at least highly automated AVP type 1 journey within the parking area and describe a motor vehicle state during the at least highly automated AVP type 1 journey of the motor vehicle, and monitoring, on the infrastructure side, the at least highly automated AVP type 1 journey of the motor vehicle on the basis of the received motor vehicle state data. An AVP system for a parking area, to a method for at least highly automated driving of a motor vehicle, to an AVP system for a motor vehicle, to a motor vehicle, to a computer program and to a machine-readable storage medium.

### CROSS-REFERENCE TO RELATED APPLICATION

This application claims the benefit of the filing date under 35 U.S.C. § 119(a)-(d) of German Patent Application No. 10 2023 122461.1 filed on Aug. 22, 2023.

### FIELD OF THE INVENTION

The invention relates to a method for monitoring, on the infrastructure side, an at least highly automated journey of a motor vehicle within a parking area, to an AVP system for an infrastructure, in particular a parking area, to a method for at least highly automated driving of a motor vehicle within a parking area, to an AVP system for a motor vehicle, to a motor vehicle, to a computer program and to a machine-readable storage medium.

### BACKGROUND

The abbreviation “AVP” stands for “Automated Valet Parking”. An AVP process comprises, for example, at least highly automated guidance of the AVP motor vehicle from a drop zone, also called a drop-off position or drop-off zone, to a parking position and, for example, at least highly automated guidance of the motor vehicle from a parking position to a pick-up position, also called a pick-up zone. At the drop-off position, i.e. the drop zone, a driver of the motor vehicle drops off the motor vehicle for an AVP process. At a pick-up position, i.e. the pick-up zone, the motor vehicle is picked up after the end of the AVP process. An AVP process thus starts in particular at the drop zone. An AVP process thus ends in particular at the pick-up zone. The pick-up zone may be the same as or different from the drop zone.

An AVP motor vehicle is therefore a motor vehicle that may participate in an AVP process.

The published patent application DE 10 2012 222 562 A1 discloses a system for managed parking spaces for transferring a vehicle from a starting position to a target position.

A solution is needed which makes it possible to efficiently monitor the motor vehicle within a parking area during an at least highly automated journey according to an AVP type 1 journey.

### SUMMARY

Monitoring, on the infrastructure side, a highly automated journey of a motor vehicle within a parking area includes receiving, on the infrastructure side, motor vehicle state data which is transmitted by the motor vehicle during an at least highly automated AVP type 1 journey within the parking area. The data describes a motor vehicle state during the at least highly automated AVP type 1 journey of the motor vehicle.

Based on the received motor vehicle state data, the at least highly automated AVP type 1 journey of the motor vehicle is monitored on the infrastructure side.

Furthermore, a parking area AVP system is provided to carry out all steps of the monitoring method.

### BRIEF DESCRIPTION OF THE DRAWINGS

The invention is explained in greater detail below on the basis of exemplary embodiments of which:

FIG. 1 shows a flowchart of a method according to the first aspect,

FIG. 2 shows a flowchart of a method according to the third aspect,

FIG. 3 shows an AVP system according to the fourth aspect,

FIG. 4 shows an AVP system according to the second aspect,

FIG. 5 shows a machine-readable storage medium according to the seventh aspect, and

FIG. 6 shows a parking area.

### DETAILED DESCRIPTION OF THE EMBODIMENTS

The same reference signs may be used for the same features below. The embodiments and exemplary embodiments described here may be combined with one another in any desired way, even if this is not explicitly described.

A first aspect provides a method for monitoring, on the infrastructure side, an at least highly automated journey of a motor vehicle within a parking area, comprising the following steps:
receiving, on the infrastructure side, motor vehicle state data which are transmitted by the motor vehicle during an at least highly automated AVP type 1 journey within the parking area and describe a motor vehicle state during the at least highly automated AVP type 1 journey of the motor vehicle,
monitoring, on the infrastructure side, the at least highly automated AVP type 1 journey of the motor vehicle on the basis of the received motor vehicle state data.

A second aspect provides an AVP system for a parking area, which is configured to carry out all steps of the method according to the first aspect.

A third aspect provides a method for at least highly automated driving of a motor vehicle within a parking area using a motor vehicle AVP system of the motor vehicle, comprising the following steps:
at least highly automated AVP type 1 driving of the motor vehicle within the parking area by way of the motor vehicle AVP system,
determining and transmitting motor vehicle state data, which describe a motor vehicle state during the at least highly automated AVP type 1 journey of the motor vehicle, to an infrastructure AVP system by way of the motor vehicle AVP system during the at least highly automated AVP type 1 journey.

A fourth aspect provides an AVP system for a motor vehicle, which is configured to carry out all steps of the method according to the third aspect.

A fifth aspect provides a motor vehicle comprising the AVP system according to the fourth aspect.

A sixth aspect provides a computer program comprising instructions which, when the computer program is executed by a computer, cause the latter to carry out a method according to the first aspect and/or according to the third aspect.

A seventh aspect provides a machine-readable storage medium on which the computer program according to the sixth aspect is stored.

The invention is based on and includes the insight that the above object is achieved by virtue of the fact that the motor vehicle is monitored on the infrastructure side on the basis of motor vehicle state data that are transmitted by the motor vehicle to the infrastructure, that is to say the AVP system of the parking area, during its at least highly automated AVP type 1 journey within the parking area. In particular, the technical advantage of transmitting the motor vehicle state data from the motor vehicle to the infrastructure is that the infrastructure, that is to say the AVP system according to the second aspect, is able to efficiently monitor the motor vehicle.

A parking area within the meaning of the description may also be referred to as a parking space and serves as a space for vehicles to park. In particular, the parking area thus forms a contiguous area which comprises a plurality of parking places (in the case of a parking area on private land) or parking zones (in the case of a parking area on public land). The parking area may be comprised by a parking garage according to one embodiment. In particular, the parking area is comprised by a garage.

The abbreviation “AVP” stands for “Automated Valet Parking”. An AVP process comprises, for example, at least highly automated guidance of the motor vehicle from a drop zone, also called a drop-off position, to a parking position and, for example, at least highly automated guidance of the motor vehicle from a parking position to a pick-up position, also called a pick-up zone. At the drop-off position, i.e. the drop zone, a driver of the motor vehicle drops off the motor vehicle for an AVP process. At a pick-up position, i.e. the pick-up zone, the motor vehicle is picked up after the end of the AVP process. An AVP process thus starts in particular at the drop zone. An AVP process thus ends in particular at the pick-up zone. The pick-up zone may be the same as or different from the drop zone.

An AVP motor vehicle is therefore a motor vehicle that may participate in an AVP process. If motor vehicle is written above and below, it should always be read that this is an AVP motor vehicle, even if the term “AVP” is not explicitly used.

The AVP process is carried out on the infrastructure side using or by way of the AVP system according to the second aspect and is carried out on the motor vehicle side using or by way of the AVP system according to the fourth aspect.

An AVP process may be an AVP process according to one of the following AVP types: AVP type 1, AVP type 2, and AVP type 3. However, the AVP types may also change within an AVP process. This means, for example, that one part of an AVP process is carried out according to AVP type 1 and another part of the AVP process is carried out according to an AVP type 2 or AVP type 3. This means, for example, that an AVP process may be divided into partial AVP processes which are each carried out according to one of the AVP types 1, 2 and 3.

AVP type 1 denotes a motor-vehicle-centric AVP process. The primary responsibility for the AVP process lies with the motor vehicle, i.e. the motor vehicle AVP system.

AVP type 2 denotes an infrastructure-centric AVP process. The primary responsibility for the AVP process lies with the infrastructure, i.e. the infrastructure AVP system.

AVP type 3 denotes an AVP process shared between the motor vehicle and the infrastructure. Here, a primary responsibility for the AVP process is shared between the motor vehicle, i.e. the motor vehicle AVP system, and the infrastructure AVP system.

An AVP process comprises the following operations or functions:
1. Determining a target position within the parking area for the motor vehicle.
2. Planning a route from a starting position that is comprised by the parking area to the target position.
3. Detecting an object and/or an event and reacting accordingly to a detected object and/or a detected event.
4. Locating the motor vehicle within the parking area.
5. Calculating a target trajectory for the motor vehicle based on the planned route.
6. Controlling lateral and longitudinal guidance of the motor vehicle based on the calculated target trajectory.

Table 1 indicates an assignment as to which of these operations or functions are carried out by the motor vehicle, i.e. the motor vehicle AVP system, or the infrastructure AVP system, depending on the AVP type, where “I” stands for “infrastructure”, i.e. the infrastructure AVP system, and “K” stands for “motor vehicle”, with the result that “I” indicates that the process is carried out by the AVP system and “K” indicates that the process is carried out by the motor vehicle:

TABLE 1
Functions by AVP type

| | AVP | AVP | AVP |
|---|---|---|---|
| Functions | type 1 | type 2 | type 3 |
| Determining a target position | I & K | I | I |
| within the parking area for the | | | |
| motor vehicle. | | | |
| Planning a route from a starting | K | I | I |
| position that is comprised by the | | | |
| parking area to the target | | | |
| position. | | | |
| Detecting an object and/or an | K (& | I | I & K |
| event and reacting accordingly | optionally | | |
| to a detected object and/or a | I) | | |
| detected event. | | | |
| Locating the motor vehicle | K | I | K |
| within the parking area. | | | |
| Calculating a target trajectory | K | I | K |
| for the motor vehicle based on | | | |
| the planned route. | | | |
| Controlling lateral and | K | K | K |
| longitudinal guidance of the | | | |
| motor vehicle based on the | | | |
| calculated target trajectory. | | | |

Table 1 above therefore indicates for each function, specifically for each AVP type, whether the function is performed by the infrastructure, i.e. by the infrastructure AVP system, or by the motor vehicle, i.e. by the motor vehicle AVP system. In some cases, provision may be made for the function to be performed by both the infrastructure AVP system and the motor vehicle.

With regard to object and event detection for AVP type 1, provision may optionally be made for the infrastructure AVP system of the infrastructure to also perform this function in addition to the motor vehicle.

AVP types 1, 2 and 3 described here are described in further detail in ISO Standard 23374-1:2021(E).

The motor vehicle is an at least highly automated motor vehicle. Such a motor vehicle is configured for at least highly automated guidance. Highly automated guidance corresponds to an automation level 3 as defined by the German Federal Highway Research Institute (BASt).

The fact that the motor vehicle is configured at least for highly automated guidance includes the case where the motor vehicle is configured for highly automated guidance as well as for fully automated guidance and for autonomous guidance. Fully automated guidance corresponds to an automation level 4 as defined by the BASt.

Highly automated guidance means that, for a certain period of time in a specific situation (for example: driving on an interstate highway, driving within a parking area, overtaking an object, driving within a lane defined by lane markings), longitudinal and lateral guidance of the motor vehicle are controlled automatically. A driver of the motor vehicle does not themself have to manually control the longitudinal and lateral guidance of the motor vehicle. The driver does not have to continuously monitor the automatic control of the longitudinal and lateral guidance in order to be able to intervene manually if necessary. If necessary, a takeover request to take over the control of the longitudinal and lateral guidance is automatically output to the driver, in particular with a sufficient time reserve. This means that the driver must potentially be able to take over the control of the longitudinal and lateral guidance. Limits of the automatic control of the lateral and longitudinal guidance are automatically recognized. With highly automated guidance, it is not possible to automatically bring about a risk-minimized state in every initial situation.

The wording “to take over the control of the longitudinal and lateral guidance” may also be replaced by the wording “to take over the longitudinal and lateral guidance”.

Fully automated guidance means that, in a specific situation (for example: driving on an interstate highway, driving within a parking area, overtaking an object, driving within a lane defined by lane markings), longitudinal and lateral guidance of the motor vehicle are controlled automatically. A driver of the motor vehicle does not themself have to manually control the longitudinal and lateral guidance of the motor vehicle. The driver does not have to monitor the automatic control of the longitudinal and lateral guidance in order to be able to intervene manually if necessary. Before the automatic control of the lateral and longitudinal guidance is stopped, the driver is automatically prompted to take over the driving task (control of the lateral and longitudinal guidance of the motor vehicle), in particular with a sufficient time reserve. If the driver does not take over the driving task, there is an automatic return to a risk-minimized state. Limits of the automatic control of the lateral and longitudinal guidance are automatically recognized. In all situations, it is possible to automatically return to a risk-minimized system state.

Autonomous guidance or driving means that longitudinal and lateral guidance of the motor vehicle are controlled automatically in all situations and not just in one or more specific situations. The driver is no longer necessary as a fallback level. The motor vehicle may therefore drive in driverless fashion. Autonomous guidance corresponds to an automation level 5 according to SAE (J3016), where SAE stands for “Society of Automotive Engineers”.

In one embodiment of the method according to the first aspect, provision is made, on the basis of the monitoring, for a decision to be made on the infrastructure side as to whether at least highly automated AVP type 2 driving of the motor vehicle within the parking area is approved or refused on the infrastructure side.

For example, this affords the technical advantage of the AVP process being able to be carried out safely.

One objective of the monitoring is to determine in particular whether driving is correct or error-free in accordance with AVP type 1. This means, for example, if it is determined on the infrastructure side that the AVP motor vehicle is not driving correctly, then (presumably) an infrastructure-side takeover by the infrastructure AVP system is not possible. For example, if the motor vehicle is far away from a route specified on the infrastructure side, i.e. outside a predetermined tolerance range, for example. If necessary, an error on the motor vehicle side can still be corrected on the motor vehicle side if, for example, the error is detected or identified on the infrastructure side and reported to the motor vehicle by the infrastructure AVP system, so that the motor vehicle can correct the error itself.

For example, if the error is or cannot be corrected, or the error is so large or problematic, the AVP operation or the AVP process is immediately aborted and one or more actions are initiated, for example.

One objective of the monitoring is in particular to check whether, for example, the correct motor vehicle is coming and is correctly identified at the AVP type 1 driving-to-AVP type 2 driving handover point or in the AVP type 1 driving-to-AVP type 2 driving handover region.

One objective of the monitoring is in particular to check whether the motor vehicle is driving correctly, for example, that is to say is driving on the (specified) route, for example, and not, for example, over parking bays and/or walkways, for example.

One objective of the monitoring is to guarantee safety, in particular.

The correct motor vehicle is then taken over by the infrastructure AVP system, with the result that it drives according to AVP type 2 after the takeover.

In one embodiment of the method according to the first aspect, provision is made for at least one handover condition to be specified to the motor vehicle on the infrastructure side and to be linked to the infrastructure-side approval of AVP type 2 driving, wherein it is checked on the infrastructure side whether the motor vehicle has met the specified at least one handover condition, wherein, on the basis of a result of the infrastructure-side checking, a decision is made on the infrastructure side as to whether at least highly automated AVP type 2 driving of the motor vehicle within the parking area is approved or refused on the infrastructure side.

For example, this affords the technical advantage of the AVP process being able to be carried out safely.

If safety cannot be guaranteed, no AVP process is carried out in particular or a running AVP process is aborted or stopped, in particular.

For example, safety cannot be guaranteed if, for example, the motor vehicle is not reliably detected or identified by the infrastructure AVP system. For example, this affords the technical advantage of being able to efficiently prevent the wrong motor vehicle from possibly being controlled by the infrastructure.

Safety cannot be guaranteed, for example, if the motor vehicle is not driving on the correct (specified) trajectory and/or route, for example, because it is partly driving in an opposite lane, for example. In such a case, there is probably an error and the current AVP process is no longer safe, with the result that, if applicable, the AVP motor vehicle can then probably not be taken over, i.e. driven, correctly by the infrastructure either.

If the motor vehicle does not comply with the infrastructure-side specifications or rules (for example a specified maximum speed), there must presumably be an error.

In general, this means in particular that the AVP operation must be aborted for safety reasons whenever it is determined, on the basis of the monitoring, that the motor vehicle is not driving correctly or is not driving according to specifications.

A handover condition is therefore in particular that the motor vehicle is driving correctly or is driving according to specifications or rules. In particular, a handover condition is that the motor vehicle is correctly identified by the infrastructure AVP system.

A specification is for example: a trajectory, a route, a target position.

A rule is for example: a maximum permissible speed, a minimum distance to an object that is to be complied with, a prohibition to drive in a certain zone or a certain region.

In one embodiment of the method according to the first aspect, provision is made for the infrastructure-side monitoring to comprise checking the plausibility of the motor vehicle state data.

For example, this affords the technical advantage of the journey of the motor vehicle being able to be monitored efficiently. For example, this affords the technical advantage of the AVP process being able to be carried out safely.

In one embodiment of the method according to the first aspect, provision is made for the infrastructure-side monitoring to comprise checking whether the motor vehicle adheres to at least one predetermined specification and/or at least one predetermined rule.

For example, this affords the technical advantage of the journey of the motor vehicle being able to be checked efficiently.

In one embodiment of the method according to the first aspect, provision is made for the infrastructure-side monitoring to comprise checking whether the motor vehicle follows a target route transferred to the motor vehicle on the infrastructure side and/or follows a target trajectory transferred to the motor vehicle on the infrastructure side, in particular follows it within a predetermined tolerance range.

For example, this affords the technical advantage of the journey of the motor vehicle being able to be checked efficiently. In particular, this affords the technical advantage of knowledge being obtained, on the infrastructure side, about whether or not the motor vehicle is following a transferred target route and/or a transferred target trajectory. In accordance with a result of this check, one action can be taken on the infrastructure side or a plurality of actions can be taken on the infrastructure side, which will be explained in more detail further below.

In one embodiment of the method according to the first aspect, provision is made for the infrastructure-side monitoring to comprise checking whether the motor vehicle, the motor vehicle state data of which have been received on the infrastructure side, is a motor vehicle which is expected on the infrastructure side as part of an AVP process.

For example, this affords the technical advantage of being able to check efficiently whether the motor vehicle is a motor vehicle which is expected on the infrastructure side as part of an AVP process.

On the basis of the monitoring, the infrastructure AVP system tracks the motor vehicle, for example. On the basis of the tracking, the infrastructure AVP system can identify the motor vehicle at the AVP type 1 driving-to-AVP type 2 driving handover point or in the AVP type 1 driving-to-AVP type 2 driving handover region.

In one embodiment of the method according to the first aspect, provision is made, if an abnormality in the behavior of the motor vehicle is detected on the infrastructure side on the basis of the monitoring and/or if an error in the behavior of the motor vehicle is detected on the infrastructure side on the basis of the monitoring, for at least one action to be carried out on the infrastructure side in order to react to what is detected.

For example, this affords the technical advantage of being able to react efficiently to a detected abnormality and/or to a detected error in the behavior of the motor vehicle.

An error is, for example, if the motor vehicle does not drive in accordance with the rules. Therefore, errors are, for example, when the motor vehicle drives, for example, over sidewalks and/or pedestrian routes and/or gardens etc. and/or against the direction of travel specified by a one-way street. A garden includes for example: grass strips and/or bed(s) between lanes and/or between paths and/or between parking spaces, i.e. in particular everything that can be or is between and/or next to and/or outside the spaces that can be driven on and/or parked in.

For example, a deviation in the route or a change in the trajectory, for example because an object is being circumvented, is an abnormality, but the behavior of the motor vehicle in this case is logical. If a behavior of the motor vehicle thus deviates from an expected behavior, but this deviation is logical, this is, for example, an abnormality.

In one embodiment of the method according to the first aspect, provision is made for the at least one action to be in each case an element selected from the following group of actions: informing the motor vehicle about what is detected, transmitting an emergency stop command to the motor vehicle, informing service personnel for the parking area about what is detected, informing one or more road users located within the parking area.

For example, this affords the technical advantage of particularly suitable actions being carried out by the infrastructure.

In one embodiment of the method according to the first aspect, provision is made for the motor vehicle state to be described by at least one kinematic variable, in particular location, speed, acceleration, jerk, and/or by a route of the motor vehicle and/or by a trajectory of the motor vehicle.

For example, this affords the technical advantage of the motor vehicle state being meaningfully described.

Statements made in connection with the method according to the first aspect apply analogously to embodiments of the method according to the third aspect and vice versa.

The method steps of the method according to the first aspect are carried out, for example, using the AVP system according to the second aspect, i.e. carried out by said system.

The method steps of the method according to the third aspect are carried out by the AVP system according to the fourth aspect.

In one embodiment, the AVP system according to the fourth aspect comprises a control unit for at least highly automated control of lateral and longitudinal guidance of the motor vehicle.

Statements made in connection with the method according to the first aspect apply analogously to the method according to the third aspect and vice versa. This means that the technical functionalities and features of the method according to the third aspect result from corresponding technical functionalities of the method according to the first aspect and vice versa.

For example, transmitting and receiving in the sense of the description is transmitting and receiving via one or more communication networks. A communication network is, for example, a WLAN network or a mobile radio network.

The AVP system according to the fourth aspect is, for example, configured by virtue of programming, to execute the computer program comprising instructions which, when the computer program is executed by a computer, cause the latter to carry out a method according to the third aspect.

The AVP system according to the second aspect is, for example, configured by virtue of programming, to execute the computer program comprising instructions which, when the computer program is executed by a computer, cause the latter to carry out a method according to the first aspect.

The method according to the first aspect and/or the method according to the third aspect is or are, for example, computer-implemented methods.

A method in the sense of the description can be carried out, for example, by way of the corresponding system.

The motor vehicle comprises, for example, one or more environmental sensors. Such environmental sensors can also be called motor vehicle environmental sensors. Such environmental sensors are included, for example, in the motor vehicle AVP system. A motor vehicle environmental sensor system comprises, for example, one or more such environmental sensors.

The AVP system comprises, for example, one or more environmental sensors which are spatially distributed within the parking area. Such environmental sensors can be referred to, for example, as infrastructure environmental sensors. An infrastructure environmental sensor system comprises, for example, one or more such infrastructure environmental sensors.

For example, the region through which the motor vehicle drives according to AVP type 1 does not comprise any infrastructure environmental sensors.

An environmental sensor, i.e. a motor vehicle environmental sensor or an infrastructure environmental sensor, is, for example, one of the following environmental sensors: radar sensor, lidar sensor, image sensor, in particular image sensor of a video camera, for example image sensors of a stereo video camera, ultrasonic sensor, magnetic field sensor, infrared sensor.

The embodiments and exemplary embodiments described here can be combined in any manner with one another, even if this is not explicitly described.

A region within which a motor vehicle is intended to drive in an at least highly automated manner according to AVP type 1 can also be referred to as an AVP type 1 region. For example, there is no AVP infrastructure monitoring by infrastructure environmental sensors for such a region.

A region within which a motor vehicle is intended to drive in an at least highly automated manner according to AVP type 2 can also be referred to as an AVP type 2 region. There is AVP infrastructure monitoring by infrastructure environmental sensors for such a region.

AVP infrastructure monitoring is monitoring by one or more infrastructure environmental sensors, wherein the monitoring data determined in the monitoring are used for the AVP process.

This may mean that there may be infrastructure environmental sensors within an AVP type 1 region. However, these are not used for AVP infrastructure monitoring. For example, one reason may be that these infrastructure environmental sensors do not meet certain safety requirements that AVP infrastructure monitoring should or can advantageously meet. Such safety requirements include, for example, one or more specific safety levels. For example, safety levels are the following safety levels: QM, ASIL-A, ASIL-B, ASIL-C, ASIL-D, SIL-1, SIL-2, SIL-3, SIL-4.

The abbreviation “ASIL” stands for “Automotive Safety Integrity Level”. “Automotive Safety Integrity Level” is a key component of the ISO26262 standard. ASIL distinguishes between four different ASIL risk levels, denoted by ASIL-A, ASIL-B, ASIL-C and ASIL-D.

The abbreviation “SIL” stands for “Safety Integrity Level”. “Safety Integrity Level” is a key component of the IEC EN 61508 standard. SIL distinguishes between four different SIL risk levels, denoted by SIL-1, SIL-2, SIL-3 and SIL-4.

QM stands for “Quality Management”, which means in particular that risks are tolerable, with the result that special safety requirements are unnecessary and only standard quality requirements are sufficient.

Infrastructure environmental sensors used for AVP monitoring comply with, for example, a higher safety level than infrastructure environmental sensors that are not used for AVP monitoring, but rather, for example, for detecting occupancy of a parking place.

At least highly automated driving of the motor vehicle by way of the motor vehicle AVP system comprises, for example, at least highly automated control of lateral and longitudinal guidance of the motor vehicle by way of the motor vehicle AVP system.

The AVP system according to the second aspect can be referred to as an infrastructure AVP system if it is implemented in an infrastructure, in particular a parking area.

The AVP system according to the fourth aspect can be referred to as a motor vehicle AVP system if it is implemented in a motor vehicle.

The same reference signs may be used for the same features below.

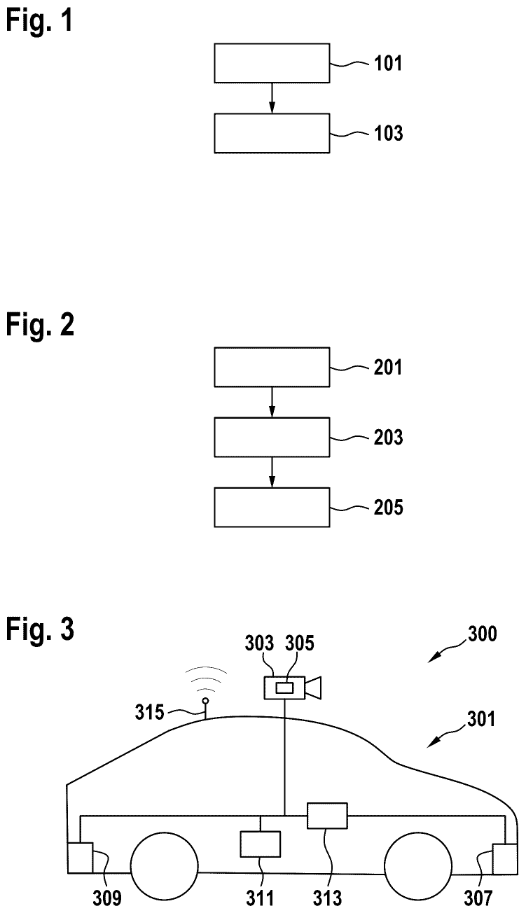

FIG. 1 shows a flowchart of a method for monitoring, on the infrastructure side, an at least highly automated journey of a motor vehicle within a parking area, comprising the following steps:
receiving 101, on the infrastructure side, motor vehicle state data which are transmitted by the motor vehicle during an at least highly automated AVP type 1 journey within the parking area and describe a motor vehicle state during the at least highly automated AVP type 1 journey of the motor vehicle,
monitoring 103, on the infrastructure side, the at least highly automated AVP type 1 journey of the motor vehicle on the basis of the received motor vehicle state data.

FIG. 2 shows a flowchart of a method for at least highly automated driving of a motor vehicle within a parking area using a motor vehicle AVP system of the motor vehicle, comprising the following steps:
at least highly automated AVP type 1 driving 201 of the motor vehicle within the parking area by way of the motor vehicle AVP system,
determining 203 and transmitting 205 motor vehicle state data, which describe a motor vehicle state during the at least highly automated AVP type 1 journey of the motor vehicle, to an infrastructure AVP system by way of the motor vehicle AVP system during the at least highly automated AVP type 1 journey.

FIG. 3 shows an AVP system 300 according to the fourth aspect, which is included or implemented in a motor vehicle 301 according to the fifth aspect. The AVP system 300 is configured to carry out all the steps of the method according to the third aspect.

By way of example, the motor vehicle AVP system 300 comprises a video camera 303 comprising an image sensor 305. The video camera 303 is arranged on the roof of the motor vehicle 301.

The motor vehicle AVP system 300 further comprises, by way of example, a first radar sensor 307 which is arranged on the front of the motor vehicle 301. The motor vehicle AVP system 300 further comprises, by way of example, a second radar sensor 309 which is arranged on the rear of the motor vehicle 301. The motor vehicle AVP system 300 further comprises, by way of example, an ultrasonic sensor 311 which is arranged on the side of the motor vehicle 301.

Thus, the motor vehicle AVP system 300 comprises a motor vehicle environmental sensor system comprising multiple environmental sensors: image sensor 305, radar sensors 307, 309, and ultrasonic sensor 311.

These environmental sensors capture an environment of the motor vehicle and output environmental sensor data based on the capture to a control unit 313 of the motor vehicle AVP system 300. The control unit 313 processes these environmental sensor data in order to guide or drive the motor vehicle in an at least highly automated manner.

The motor vehicle AVP system 300 further comprises a wireless communication interface 315 which is configured to communicate with an infrastructure AVP system (not shown).

Communication in the sense of the description comprises transmitting and receiving.

At this point, it is noted that more or fewer and/or other environmental sensors can be provided instead of or in addition to the environmental sensors shown in FIG. 3.

At this point, it is noted that a plurality of control units can be provided instead of or in addition to the control unit 313 shown in FIG. 3.

In an embodiment that is not shown, provision is made for the motor vehicle AVP system 300 to not comprise any motor vehicle environmental sensors. In this case, the motor vehicle environmental sensors are already part of the motor vehicle 301.

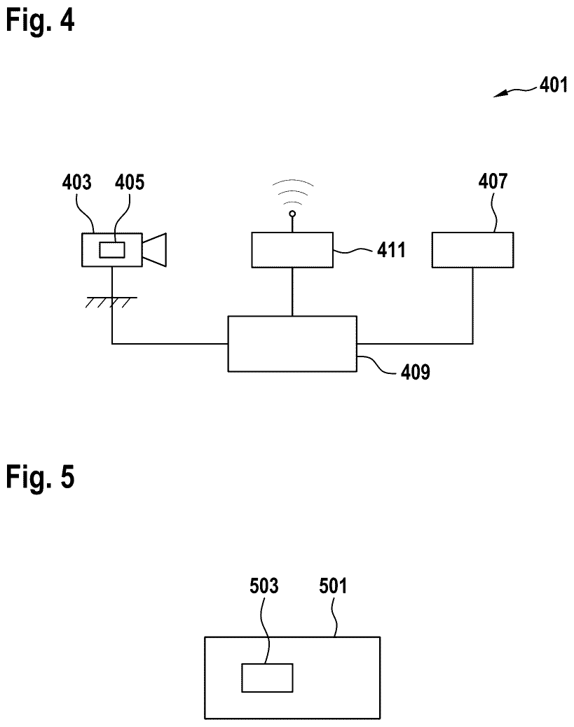

FIG. 4 shows an AVP system 401 according to the second aspect. The AVP system 401 is configured to carry out all the steps of the method according to the first aspect.

By way of example, the AVP system 401 comprises a video camera 403 comprising an image sensor 405. By way of example, the AVP system 401 comprises a radar sensor 407.

These environmental sensors are spatially distributed within a parking area (not shown) and each capture a region of the parking area. Environmental sensor data based on the capture from these environmental sensors are output to a data processing device 409 which processes the environmental sensor data and, for example based thereon, determines infrastructure assistance data for assisting an at least highly automated motor vehicle during an AVP process.

At this point, it is noted that more or fewer and/or other environmental sensors can be provided instead of or in addition to the environmental sensors shown in FIG. 4.

The infrastructure AVP system 401 further comprises a wireless communication interface 411 which is configured to communicate with one or more at least highly automated motor vehicles which are located within the parking area.

For example, the AVP system 401 comprises a plurality of such wireless communication interfaces 411 which are spatially distributed within the parking area in order to achieve sufficient radio coverage.

The data processing device 409 may comprise, for example, one or more servers, one or more of which, for example, can be implemented in a cloud infrastructure.

In an embodiment that is not shown, provision is made for the AVP system 401 to not comprise any infrastructure environmental sensors. In this case, the infrastructure environmental sensors are already part of the parking area.

The region of the parking area within which the motor vehicle is intended to drive or drives according to AVP type 1 is not equipped, in particular, with such infrastructure environmental sensors.

FIG. 5 shows a machine-readable storage medium 501 according to the seventh aspect, on which a computer program 503 according to the sixth aspect is stored.

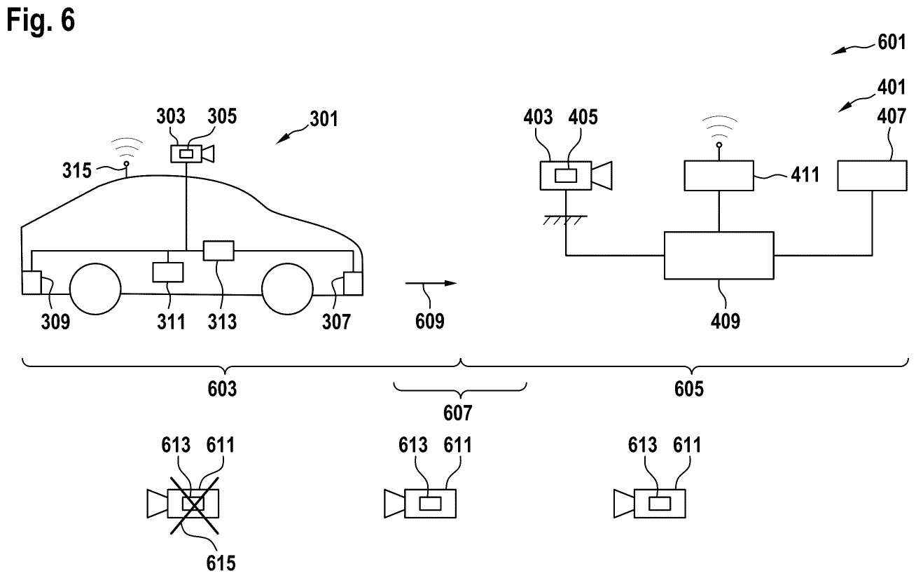

FIG. 6 shows a parking area 601, within which the AVP system 401 from FIG. 4 is implemented.

Within the parking area 601, a plurality of regions are stipulated or defined for example: a first region 603, a second region 605 and a third region 607, which overlaps the first region 603 and the second region 605. The first region and the second region 605 are arranged immediately in succession, i.e. directly adjacent to each other.

By way of example, the motor vehicle 301 from FIG. 3 drives in an at least highly automated manner within the parking area 601. A direction of travel of the motor vehicle 301 is indicated by an arrow with the reference sign 609.

FIG. 6 depicts a plurality of video cameras 611 each comprising an image sensor 613. In detail, such a video camera 611 is depicted for each of the regions shown in FIG. 6. At this point, it is noted that other and/or further environmental sensors can be provided instead of or in addition to the video camera 611.

The video cameras 611 shown are intended to symbolize that there is or is not monitoring by infrastructure environmental sensors for the corresponding region. If there is no such monitoring, the video camera 611 shown accordingly is crossed with an “X” with the reference sign 615.

Within the first region 603 for which AVP infrastructure monitoring by infrastructure environmental sensors is not provided, the motor vehicle is intended to drive during the AVP process according to AVP type 1. For the second region 605, the motor vehicle is intended to drive according to AVP type 2.

The third region 607 is a handover region within which the AVP process is intended to switch from AVP type 1 to AVP type 2. This means that the responsibility for driving changes from the motor vehicle AVP system 300 of the motor vehicle 301 to the infrastructure AVP system 401 of the parking area 601. There is monitoring by infrastructure sensors within the handover region.

As part of the handover process, the infrastructure AVP system 401, for example, locates the motor vehicle 301 on the basis of data transmitted by the motor vehicle AVP system 300 to the infrastructure AVP system 401 during the AVP type 1 journey of the motor vehicle 301 within the first region 603.

In general, the data transmitted by the motor vehicle AVP system 300 to the infrastructure AVP system 401 during the AVP type 1 journey of the motor vehicle 301 within the first region 603 are used by the infrastructure AVP system 401 to monitor the motor vehicle 301.

What is claimed is:

1. A method for monitoring, on the infrastructure side, a highly automated journey of a motor vehicle within a parking area, comprising:
receiving, on the infrastructure side, motor vehicle state data which are transmitted by the motor vehicle during an at least highly automated AVP type 1 journey within the parking area and describe a motor vehicle state during the at least highly automated AVP type 1 journey of the motor vehicle; and
monitoring, on the infrastructure side, the at least highly automated AVP type 1 journey of the motor vehicle on the basis of the received motor vehicle state data.

2. The method of claim 1, wherein, on the basis of the monitoring, a decision is made on the infrastructure side as to whether at least highly automated AVP type 2 driving of the motor vehicle within the parking area is approved or refused on the infrastructure side.

3. The method of claim 2, wherein at least one handover condition is specified to the motor vehicle on the infrastructure side and is linked to the infrastructure-side approval of AVP type 2 driving, wherein on the infrastructure side whether the motor vehicle has met the specified at least one handover condition is checked, wherein, on the basis of a result of the infrastructure-side checking, a decision is made on the infrastructure side as to whether at least highly automated AVP type 2 driving of the motor vehicle within the parking area is approved or refused on the infrastructure side.

4. The method of claim 1, wherein the infrastructure-side monitoring comprises checking the plausibility of the motor vehicle state data.

5. The method of claim 1, wherein the infrastructure-side monitoring comprises checking whether the motor vehicle adheres to at least one predetermined specification and/or at least one predetermined rule.

6. The method of claim 1, wherein the infrastructure-side monitoring comprises checking whether the motor vehicle follows a target route transferred to the motor vehicle on the infrastructure side and/or follows a target trajectory transferred to the motor vehicle on the infrastructure side, in particular follows it within a predetermined tolerance range.

7. The method of claim 4, wherein the infrastructure-side monitoring comprises checking whether the motor vehicle, the motor vehicle state data of which have been received on the infrastructure side, is a motor vehicle which is expected on the infrastructure side as part of an AVP process.

8. The method of claim 7, wherein, if an abnormality in the behavior of the motor vehicle is detected on the infrastructure side on the basis of the monitoring and/or if an error in the behavior of the motor vehicle is detected on the infrastructure side on the basis of the monitoring, at least one action is carried out on the infrastructure side in order to react to what is detected.

9. The method of claim 8, wherein the at least one action is in each case an element selected from the following group of actions: informing the motor vehicle about what is detected, transmitting an emergency stop command to the motor vehicle, informing service personnel for the parking area about what is detected, informing one or more road users located within the parking area.

10. The method claim 1, wherein the motor vehicle state is described by at least one kinematic variable, in particular location, speed, acceleration, jerk, and/or by a route of the motor vehicle and/or by a trajectory of the motor vehicle.

11. An AVP system for a parking area, which is configured to carry out all steps of the method as claimed in claim 1.

12. A method for automated driving of a motor vehicle within a parking area using a motor vehicle AVP system of the motor vehicle, comprising the steps of:
at least highly automated AVP type 1 driving of the motor vehicle within the parking area by way of the motor vehicle AVP system; and
determining and transmitting motor vehicle state data, which describe a motor vehicle state during the at least highly automated AVP type 1 journey of the motor vehicle, to an infrastructure AVP system by way of the motor vehicle AVP system during the at least highly automated AVP type 1 journey.

13. An AVP system for a motor vehicle, which is configured to carry out all steps of the method as claimed in claim 12.

14. A motor vehicle comprising the AVP system as claimed in claim 13.

15. A computer program comprising instructions which, when the computer program is executed by a computer, cause the latter to carry out a method of claim 1.

16. A non-transitory machine-readable storage medium on which the computer program as claimed in claim 15 is stored.
